(19) United States
(12) Patent Application Publication
(10) Pub. No.: US 2017/0286057 A1
(43) Pub. Date: Oct. 5, 2017

(54) METHOD AND SYSTEM FOR VOLUME CONTROL BY HAND GESTURE

(71) Applicant: FiiO Electronics Technology Co., Ltd., Guangzhou (CN)

(72) Inventor: Guangsheng Zhang, Dongguan (CN)

(21) Appl. No.: 15/412,080

(22) Filed: Jan. 23, 2017

(30) Foreign Application Priority Data
Mar. 31, 2016 (CN) 201610203821.4

(51) Int. Cl. G06F 3/16; G06F 3/0488

(52) U.S. Cl. CPC G06F 3/165; G06F 3/0488

(57) ABSTRACT

A method and system for volume control by hand gesture, comprising the following steps: enter music playing interface, and control the music volume and system volume, conduct hand gesture operation and pop up volume control interface; conduct volume control by hand gesture in the volume control interface, and conduct the corresponding operation for the music volume according to the volume control by hand gesture. If the direction of volume control by hand gesture is upward, the volume increases, and vice versa. Click the volume control symbol on the volume control interface to control the music volume accordingly; or return to the music playing interface if the volume control by hand gesture is not conducted on the volume control interface within the set time, or “Return” key is clicked.

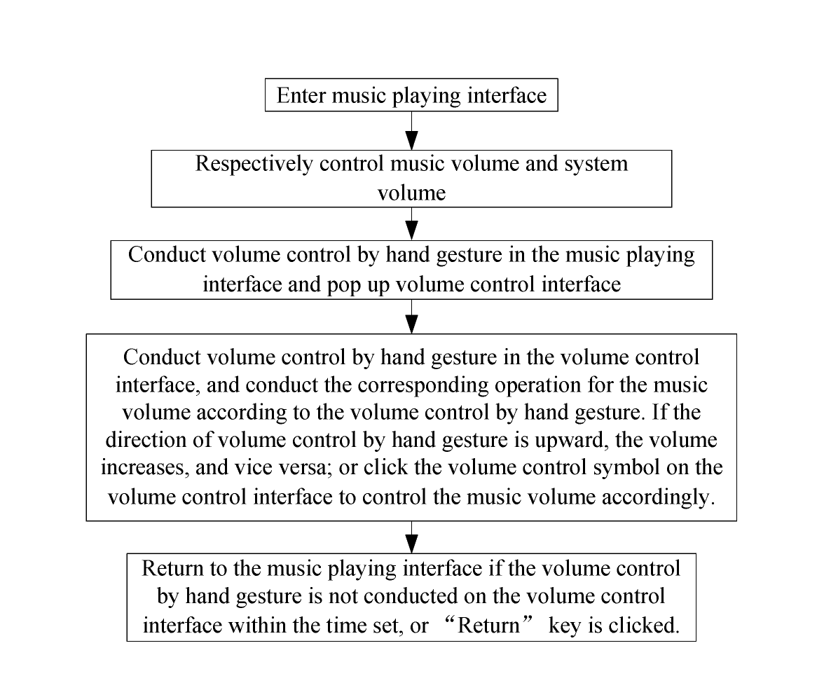

### CROSS REFERENCE TO RELATED APPLICATIONS

The present application claims the benefit of Chinese Patent Application No. 201610203821.4 filed on Mar. 31, 2016, the contents of which are hereby incorporated by reference.

### TECHNICAL FIELD

The Invention relates to the field of network communication technology, in particular to a method for volume control by hand gesture.

### BACKGROUND ART

To control volume in the conventional music playing interface, the user needs to click a blank area of the playing interface to firstly pop up the music control sub-interface, then click ACTION_MOVE or manually drag mover to control volume, or operate a physical volume control key on the player enclosure; such operations are complex for the user who wants to control volume easily and quickly. Additionally, the current control of music volume is synchronous with that of system volume, however, sometime the user does not want to control the system volume at the same time with the music control.

### SUMMARY OF THE INVENTION

The Invention provides a method for volume control by hand gesture and system thereof, which can simplify the complex operations in the prior art, and address the problem of synchronous control of the music volume with that of the system volume.

The technical scheme of the Invention is realized as follows: a method for volume control by hand gesture, comprising the following steps:
Step 1, entering music playing interface;
Step 2, respectively controlling music volume and system volume;
Step 3, conducting hand gesture operation in the music playing interface and popping up the volume control interface;
Step 4, conducting volume control by hand gesture in the volume control interface, and conducting the corresponding operation for the music volume according to the volume control by hand gesture. If the direction of volume control by hand gesture is upward, the volume increases, and vice versa. Click the volume control symbol on the volume control interface to control the music volume accordingly;
Step 5, returning to the music playing interface if the volume control by hand gesture is not conducted on the volume control interface within the set time, or “Return” key is clicked.

Further, there includes the following steps between Step (1) and Step (2): judging whether the music playing interface is entered: the interface playing interface comprises album front cover area, lyrics area, ID3 area and song switchover area. Obtaining the information of each area on the current interface. If two of the album front cover area, lyrics area, ID3 area and song switchover area are included at least, confirm to enter the music playing interface, and send message to gain control module after confirmation.

Further, the volume increase or decrease operation in Step 4 comprises the following steps: Sending audio data to gain control module, and the gain control module will accordingly increase or decrease volume according to the correspondence between volume control by hand gesture and volume output gain.

Further, the method of judging the direction of volume control by hand gesture is as follows: Setting coordinate system on the volume control interface, obtaining the displacement of volume control by hand gesture, and judging whether the projection of the displacement on Y-axis is positive; if yes, the direction of volume control by hand gesture is upward, and vice versa.

A system for volume control by hand gesture, comprising gain control module, interface acquisition module, displacement judgment module, and interface control module;

The interface control module is used for entering music playing interface, popping up volume control interface after the hand gesture operation is sensed and controlling the display status of volume control interface;

The interface acquisition module is used for acquiring the area information of the current interface, judging the entry into music playing interface, and respectively controlling the music volume and system volume after entry into the music playing interface; or reversely controlling the volume controlled after exiting from the volume control interface;

The displacement judgment module is used for acquiring the displacement of volume control by hand gesture to judge its direction; and the gain control module is used for increasing or decreasing the volume according to the direction of volume control by hand gesture. Further, the two ends of the volume control interface are respectively provided with volume increase and volume decrease buttons.

The beneficial effects of the Invention are that the volume is controlled by hand gesture directly in the music playing interface, and the volume control sub-interface will pop up automatically; the volume may be increased by moving upwards, and vice versa; if any operation is not conducted within the set time, volume control interface will exit automatically.

The way of volume control by hand gesture, more intelligent and user-friendly, requires few operations of the user and offers the user with an unparalleled experience.

### BRIEF DESCRIPTION OF THE DRAWINGS

In order to illustrate the technical schemes in the embodiments of the Invention or in prior art more clearly, the drawings required in description of the embodiments or prior art will be introduced briefly as follows. Obviously, the drawings described below are just a part of the embodiments of the Invention. A person skilled in the art is able to obtain other drawings based on these drawings without any creative work.

The figure is the flow chart of the method for volume control by hand gesture provided by the Invention.

### DETAILED DESCRIPTION OF THE PREFERRED EMBODIMENTS

A clear and full description of the technical schemes of the embodiments of the Invention will be given in combination of the drawings of the embodiments of the Invention as follows. Obviously, the described embodiments are just a part rather than the whole of the embodiments of the Invention. Based on the embodiments of the Invention, any other embodiments obtained by a person skilled in the art without any creative work will fall within the protection scope of the Invention.

As shown in the figure, the invention provides a method for volume control by hand gesture, wherein the volume is controlled by hand gesture directly in the music playing interface, and the volume control sub-interface will pop up automatically; by moving upwards the volume may be increased, and vice versa; if any operation is not conducted within the set time, volume control interface will exit automatically. The way of volume control by hand gesture, more intelligent and user-friendly, requires few operations of the user and offers the user with an unparalleled experience.

### Embodiment 1

The Invention comprises the following steps:

Step 1, enter music playing interface; only when entry into the music playing interface is guaranteed can the invention function to ensure no system volume control of the music player synchronous with the music volume control. Sometime, the user needs to press physical volume control key to increase volume while they are playing music on mobile phone. However, the message sound and incoming call volume of the mobile phone will be increased synchronously. Additionally, if a short message comes just at this time, and the sound of the short message will be loud, bringing the user poor satisfaction and experience.

There includes the following steps between Step (1) and Step (2): Judge whether the music playing interface is entered: the interface playing interface comprises album front cover area, lyrics area, ID3 area and song switchover area. Obtain the information of each area on the current interface. If two of the album front cover area, lyrics area, ID3 area and song switchover area are included at least, confirm to enter music playing interface, and send message to gain control module after confirmation.

Step 2, respectively control music volume and system volume;

Step 3, conduct hand gesture operation in the music playing interface and synchronously pop up volume control interface;

Step 4, conduct volume control by hand gesture in the volume control interface, and conduct the corresponding operation for the music volume according to the volume control by hand gesture. If the direction of volume control by hand gesture is upward, the volume increases, and vice versa. Click the volume control symbol on the volume control interface to control the music volume accordingly;

the method of judging the direction of volume control by hand gesture is as follows: Set coordinate system on the volume control interface, obtain the displacement of volume control by hand gesture, and judge whether the projection of the displacement on Y-axis is positive; if yes, the direction of volume control by hand gesture is upward, and vice versa.

The volume increase or decrease operation in Step 4 comprises the following steps: Send audio data to gain control module, and the gain control module will accordingly increase or decrease volume according to the correspondence between volume control by hand gesture and volume output gain.

Step 5, return to the music playing interface, if the volume control by hand gesture is not conducted on the volume control interface within the set time, or “Return” key is clicked.

### Embodiment 2

Step 1, enter music playing interface;

There includes the following steps between Step (1) and Step (2): Judge whether the music playing interface is entered: the interface playing interface comprises album front cover area, lyrics area, ID3 area and song switchover area. Obtain the information of each area on the current interface. If two of the album front cover area, lyrics area, ID3 area and song switchover area are included at least, confirm to enter music playing interface, and send message to gain control module after confirmation.

Step 2, volume control comprises control music volume and system volume;

Step 3, conduct hand gesture operation in the music playing interface and synchronously pop up volume control interface;

Step 4, conduct volume control by hand gesture in the volume control interface, and conduct the corresponding operation for the music volume according to the volume control by hand gesture. If the direction of volume control by hand gesture is upward, the volume increases, and vice versa. Click the volume control symbol on the volume control interface to control the music volume accordingly;

The method of judging the direction of volume control by hand gesture is as follows: Set coordinate system on the volume control interface, obtain the displacement of volume control by hand gesture, and judge whether the projection of the displacement on Y-axis is positive; if yes, the direction of volume control by hand gesture is upward, and vice versa.

The volume increase or decrease operation in Step 4 comprises the following steps: Send audio data to gain control module, and the gain control module will accordingly increase or decrease volume according to the correspondence between volume control by hand gesture and volume output gain.

There includes the following steps between Step 4 and Step 5: The volume increase or decrease of gain control module will increase or decrease the volume of music volume and system volume accordingly. To solve the problem of higher system volume, we need to judge the volume output is the music volume or system volume. If it is music sound, the music sound will be output according to the volume increase or decrease operation of the gain control module. If it is system sound, the system sound will be output after reverse operation of the gain control module. The system sound comprises short message sound and/or incoming call sound.

Step 5, return to the music playing interface if the volume control by hand gesture is not conducted on the volume control interface within the set time, or “Return” key is clicked.

### Embodiment 3

The Invention comprises the following steps:

Step 1, enter music playing interface; only when entry into the music playing interface is guaranteed can the invention function to ensure no system volume control of the music player synchronous with the music volume control. Sometime, the user needs to press physical volume control key to increase volume while they are playing music on mobile phone. However, the message sound and incoming call volume of the mobile phone will be increased synchronously. Additionally, if a short message comes just at this time, and the sound of the short message will be loud, bringing the user poor satisfaction and experience.

There includes the following steps between Step (1) and Step (2): Judge whether the music playing interface is entered: the interface playing interface comprises album front cover area, lyrics area, ID3 area and song switchover area. Obtain the information of each area on the current interface. If two of the album front cover area, lyrics area, ID3 area and song switchover area are included at least, confirm to enter music playing interface, and send message to gain control module after confirmation.

Step 2, respectively control music volume and system volume; two gain control modules may be set to respectively control the increase or decrease of music volume and system volume.

Step 3, conduct hand gesture operation in the music playing interface and synchronously pop up volume control interface;

Step 4, conduct volume control by hand gesture in the volume control interface, and conduct the corresponding operation for the music volume according to the volume control by hand gesture. If the direction of volume control by hand gesture is upward, the volume increases, and vice versa. Click the volume control symbol on the volume control interface to control the music volume accordingly;

The method of judging the direction of volume control by hand gesture is as follows: Set coordinate system on the volume control interface, obtain the displacement of volume control by hand gesture, and judge whether the projection of the displacement on Y-axis is positive; if yes, the direction of volume control by hand gesture is upward, and vice versa.

The volume increase or decrease operation in Step 4 comprises the following steps: Send audio data to gain control module, and the gain control module will accordingly increase or decrease volume according to the correspondence between volume control by hand gesture and volume output gain.

Step 5, return to the music playing interface if the volume control by hand gesture is not conducted on the volume control interface within the set time, or “Return” key is clicked.

### Embodiment 4

The Invention comprises the following steps:

Step 1, enter music playing interface;

There includes the following steps between Step (1) and Step (2): Judge whether the music playing interface is entered: the interface playing interface comprises album front cover area, lyrics area, ID3 area and song switchover area. Obtain the information of each area on the current interface. If two of the album front cover area, lyrics area, ID3 area and song switchover area are included at least, confirm to enter music playing interface, and send message to gain control module after confirmation.

Step 2, respectively control music volume and system volume;

Step 3, conduct hand gesture operation in the music playing interface and synchronously pop up volume control interface;

Step 4, conduct volume control by hand gesture in the volume control interface, and conduct the corresponding operation for the music volume according to the volume control by hand gesture. If the direction of volume control by hand gesture is upward, the volume increases, and vice versa. Click the volume control symbol on the volume control interface to control the music volume accordingly;

The method of judging the direction of volume control by hand gesture is as follows: Set coordinate system on the volume control interface, obtain the displacement of volume control by hand gesture, and judge whether the projection of the displacement on Y-axis is positive; if yes, the direction of volume control by hand gesture is upward, and vice versa.

The volume increase or decrease operation in Step 4 comprises the following steps: Send audio data to gain control module, and the gain control module will accordingly increase or decrease volume according to the correspondence between volume control by hand gesture and volume output gain.

Step 5, return to the music playing interface if the volume control by hand gesture is not conducted on the volume control interface within the set time, or “Return” key is clicked.

Further, the embodiment comprises Step 6; if exit from music playing interface, the gain control module conducts reverse operation to make the volume control back to its original status. Generally, the original volume is the most commonly used status of the user. Nevertheless, it will no longer be applicable for the situation when the user stays on street or bus, and the user needs to increase the volume for good listening effect of the music played. When the user comes back home from outdoor, and clicks music player again indoor, the volume needs to be decreased again, which is problematic for the user. Through Step 6, the original volume status is kept and there is no need for frequent adjustment.

Additionally, in another situation, the user listens to the music with headphones under certain volume, and over times, feels unconformable and needs to decrease the volume. If the volume decreased is not recovered to its original status, after rest for some time, the user has recovered to their best capture capacity for outside volume, at this time, the volume decreased is too low for the user, bringing the user poor hearing effect. Therefore, in Step 6 provided in the Invention, the best volume is to be determined by the user, and the volume beyond the best volume range may be recovered to the best state, bringing the user good experience.

The Invention also provides a system for volume control by hand gesture, comprising gain control module, interface acquisition module, displacement judgment module, and interface control module;

The interface control module is used for entering music playing interface, popping up volume control interface after the hand gesture operation is sensed and controlling the display status of volume control interface;

The interface acquisition module is used for acquiring the area information of the current interface, judging the entry into music playing interface, and respectively controlling the music volume and system volume after entry into the music playing interface; or reversely controlling the volume controlled after exiting from the volume control interface;

The displacement judgment module is used for acquiring the displacement of volume control by hand gesture to judge its direction; and the gain control module is used for increasing or decreasing the volume according to the direction of volume control by hand gesture. The two ends of the volume control interface are respectively provided with volume increase and volume decrease buttons.

In the invention, the volume may be directly controlled by hand gesture in the album front cover area/lyrics area/ID3 area of the music playing interface, and the music control sub-interface will automatically pop up to display the current volume level; Moving up can increase the volume, and vice versa. Also, the user may click “+” or “−” to gradually increase or decrease the volume. If any operation is not conducted within 3 seconds, volume control interface will exit automatically, or the user may click “Return” key at the bottom of the screen to return to the music playing interface. The way of increasing or decreasing volume by hand gesture, more intelligent and user-friendly, requires few operations of the user and offers the user with an unparalleled experience.

Compared to the conventional click way, the Invention has the differences as follows:

A. Different operation way: the conventional operation is to click button, while the Invention is to respond to volume control and pop up the volume control sub-interface by hand gesture;

B. Different technical difficulty: the operation way of clicking button only needs to identify the coordinate of the point touched for identifying the key types and responding to the corresponding function, while the hand gesture action claimed in the Invention needs to identify the designated gesture in the designated response area, and then respond to volume control. The recognition algorithm is more complicated.

Main techniques and algorithm

Define an appropriate View in the right area of the playing interface, the rewrite View functionally, mainly touch and ACTION MOVE gesture events. When the ACTION_DOWN event of hand gesture area is detected, volume indication dialog will pop up on View, meanwhile the current ACTION_DOWN screen coordinate is recorded. Then, View will go to ACTION_MOVE event detected after ACTION_DOWN. According to the positive and negative relations, it may be known whether the gesture is MOVE_DOWN or MOVE_UP. Increase or decrease the volume and renew UI according to different situations. When touch gesture of the VIEW is completed, set the volume as completed and adjust the timer to start timing. After 3 seconds, exit dialog.

Compared to the conventional volume control by clicking screen, dragging volume mover or using physical volume control key, the volume control by special hand gesture provided in the invention can realize rapid access into the volume control condition and pop up the suspended sub-interface displaying the current volume level, and is characterized by fewer control operations and easy operation. The invention can bring the user with excellent use experience, and make the volume control function of the player easier, more rapid, intelligent and user-friendly.

Most of electronic products like mobile phone are incorporated with hand gesture by virtue of its convenience, intelligence and user-friendliness. To fully reflect the tenet of “Funs infinite” of music lovers, and consider the convenience and novelty of use experience, electronic products are incorporated with hand gesture to provide music lovers with more operation options and more funs. In spite of load increase due to addition of software identification and handling after the hand gesture control function is adopted, it is worthy of all efforts to offer the user with good experience, and better economic benefits can be obtained accordingly.

In the music playing interface, the volume may be directly controlled by hand gesture (like Move up/down, Move left/right and Move diagonally), and volume control interface will automatically pop up for gradual volume control. The user can click other areas of the volume control interface or click the “Return” key at the bottom of the screen to return to the playing interface.

The above are the preferred embodiments rather than the limitations of the Invention. Any amendment, equivalent replacement and improvement made within the range of the spirit and rule of the Invention shall be included in the protection scope of the Invention.

1. A method for volume control by hand gesture, comprising the following steps:
Step 1, entering music playing interface;
Step 2, respectively controlling music volume and system volume;
Step 3, conducting hand gesture operation in the music playing interface and popping up the volume control interface;
Step 4, conducting volume control by hand gesture in the volume control interface, and conducting the corresponding operation for the music volume according to the volume control by hand gesture, if the direction of volume control by hand gesture is upward, the volume increases, and vice versa,; clicking the volume control symbol on the volume control interface to control the music volume accordingly;
Step 5, returning to the music playing interface if the volume control by hand gesture is not conducted on the volume control interface within the set time, or “Return” key is clicked.

2. The method for volume control by hand gesture according to claim 1, further comprising the following steps between Step (1) and Step (2):
judging whether the music playing interface is entered: the interface playing interface comprises album front cover area, lyrics area, ID3 area and song switchover area, obtaining the information of each area on the current interface, if two of the album front cover area, lyrics area, ID3 area and song switchover area are included at least, confirming to enter the music playing interface, and send message to gain control module after confirmation.

3. The method for volume control by hand gesture according to claim 2, wherein, the volume increase or decrease operation in Step 4 comprises the following steps:
sending audio data to gain control module, and the gain control module will accordingly increase or decrease volume according to the correspondence between volume control by hand gesture and volume output gain.

4. The method for volume control by hand gesture according to claim 3, wherein, the method of judging the direction of volume control by hand gesture is as follows:
setting coordinate system on the volume control interface, obtaining the displacement of volume control by hand gesture, and judging whether the projection of the displacement on Y-axis is positive; if yes, the direction of volume control by hand gesture is upward, and vice versa.

5. A system for volume control by hand gesture, comprising a gain control module, an interface acquisition module, a displacement judgment module, and an interface control module;
wherein the interface control module is used for entering music playing interface, popping up volume control interface after the hand gesture operation is sensed and controlling the display status of volume control interface;
the interface acquisition module is used for acquiring the area information of the current interface, judging whether entry into music playing interface, and respectively controlling the music volume and system volume after entry into the music playing interface; or reversely controlling the volume controlled after exiting from the volume control interface;
the displacement judgment module is used for acquiring the displacement of volume control by hand gesture to judge its direction; and the gain control module is used for increasing or decreasing the volume according to the direction of volume control by hand gesture.

6. The system for volume control by hand gesture according to claim 5, wherein, the two ends of the volume control interface are respectively provided with volume increase and volume decrease buttons.
